(19) United States
(12) Patent Application Publication
(10) Pub. No.: US 2010/0153941 A1
(43) Pub. Date: Jun. 17, 2010

(54) FLEXIBLE CONTENT UPDATE VIA DEPLOYMENT ORDER TEMPLATE

(76) Inventors: Lazar Borissov, Sofia (BG); Nina Simeonova, Sofia (BG); Angel Tokmakchiev, Sofia (BG)

Correspondence Address: SAP AG, 3410 HILLVIEW AVENUE, PALO ALTO, CA, 94304, US

(21) Appl. No.: 12/333,402

(22) Filed: Dec. 12, 2008

(51) Int. Cl. G06F 9/44

(52) U.S. Cl. 717/168

(57) ABSTRACT

Described herein are a system and a method for multi-functional software solution updates, which use a deployment order template. The deployment order template contains a plurality of action instructions and deployable component definitions. The method calculates an individual deployment sequence for each specific update scenario according to a plurality of deployable components available for update and the deployment order template. If some deployable components require as a prerequisite the execution of some steps, these steps are executed prior to the update of the depending components. If some deployable components require the execution of some steps after they have been updated, these steps are executed after the update occurs. If some of the deployable components specified in the deployment order template are not available for update, the deployment sequence skips the steps associated with these deployable component.

### FIELD OF THE INVENTION

The field of the invention relates generally to software, and particularly but not exclusively, relates to techniques for multi-functional software solution update.

### BACKGROUND OF THE INVENTION

A multi-functional software solution is a software having a number of different components working together to provide a variety of functionality and services. During update, such software solutions require a number of maintenance tools and procedures to deal with the different sets of content for update. The target of the update procedure may be the entire software system, a complete functional subset of the system, or a particular minor software component. In any of these scenarios, the maintenance procedure is different and maintenance tools have to adapt the deployment sequence accordingly.

A universal update technique is needed, able to perform a wide variety of update procedures, dealing equally effective with all kind of update requirements. A viable solution would be an update technique using a deployment order definition file to calculate an individual deployment sequence for each specific update scenario. With the deployment order definition file containing the required action instructions for each specific deployable component, such a technique can be easily adapted to update effectively any set of deployable components.

### SUMMARY OF THE INVENTION

Described herein are a system and a method for multi-functional software solution updates, which use a deployment order template. The deployment order template contains a plurality of action instructions and deployable component definitions. The method calculates an individual deployment sequence for each specific update scenario according to a plurality of deployable components available for update and the deployment order template. If some deployable components require as a prerequisite the execution of some steps, these steps are executed prior to the update of the depending components. If some deployable components require the execution of some steps after they have been updated, these steps are executed after the update occurs. If some of the deployable components specified in the deployment order template are not available for update, the deployment sequence skips the steps associated with these deployable components.

### BRIEF DESCRIPTION OF THE DRAWINGS

A better understanding of the present invention can be obtained from the following detailed description in conjunction with the following drawings, in which:

FIG. 1 is a block diagram of a system for a multi-functional software solution update, in accordance with an embodiment of the present invention.

FIG. 2 is a flow diagram of a process for updating components of a multi-functional software solution, in accordance with an embodiment of the present invention.

FIG. 3 is a sequence diagram of a process for updating components of a multi-functional software solution, in accordance with an embodiment of the present invention.

FIG. 4 is an example of a document type definition (DTD) file describing a deployment order template (DOT), in accordance with an embodiment of the present invention.

FIG. 5 is an exemplary extensible markup language (XML) representation of a DOT example, in accordance with an embodiment of the present invention.

### DETAILED DESCRIPTION

Embodiments of a system and a method of a multi-functional software solution update are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “this embodiment” means that a particular feature, structure, or characteristic described in connection with the embodiment is included in at least one embodiment of the present invention. Thus, the appearances of the phrases “in one embodiment” or “in this embodiment” in various places throughout this specification are not necessarily all referring to the same embodiment. Furthermore, the particular features, structures, or characteristics may be combined in any suitable manner in one or more embodiments.

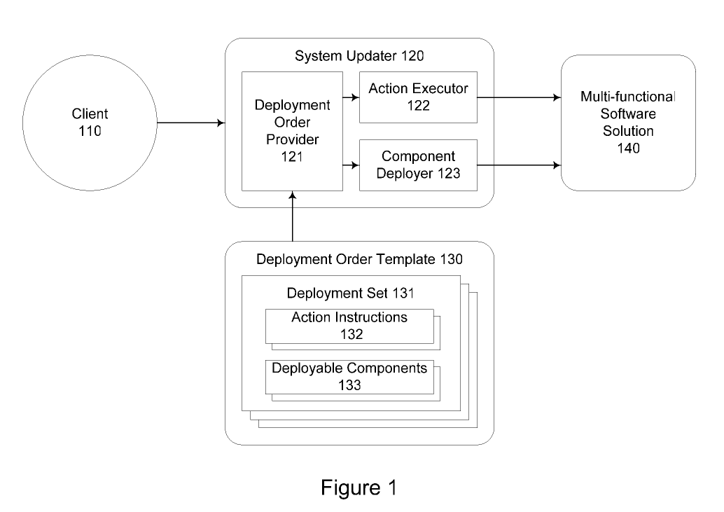

FIG. 1 is a block diagram of a system for a multi-functional software solution update. The multi-functional software solution 140 is a software having a number of different components working together to provide a variety of functionality and services. The client 110 triggers an update procedure by a call to the system updater 120. Within this call, the client 110 specifies a location containing a number of available for update deployment component archives. The system updater 120 creates a deployment order provider 121 using the update information provided by the deployment order template (DOT) 130. The DOT 130 consists of a plurality of deployment sets 131. Each deployment set has a plurality of action instructions 132 and a plurality of deployable components 133. Having the available for update deployment component archives provided by the client, the deployment order provider 121 calculates a deployment sequence by extracting the information from the DOT 130. The deployment order provider 121 forwards the action instructions 132 from the calculated deployment sequence to the action executor 122, which executes the instructions on the multi-functional software solution 140. The component deployer 123 updates the deployable components 133 from the calculated deployment sequence on the multi-functional software solution 140. In one embodiment of the present invention, there may be a plurality of action instructions 132 defined for each deployable component 133. In this embodiment, there are two types of action instructions 131 described in the DOT 130: pre-actions and post-actions. The pre-actions are executed by the action executor 122 prior to component deployment and the post-actions are executed after the components are deployed. If the deployable components 133 that require the execution of the action instructions 132 are not available for update, the action instructions 132, associated with the missing deployable components, will not be included in the deployment sequence. Therefore, the deployment order provider 121 will produce a correct deployment sequence for any set of deployment components available for update.

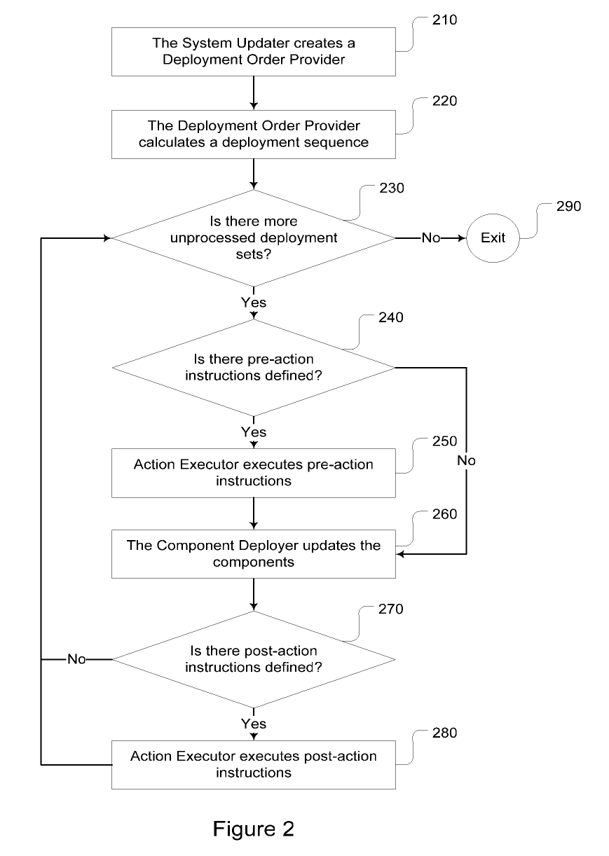

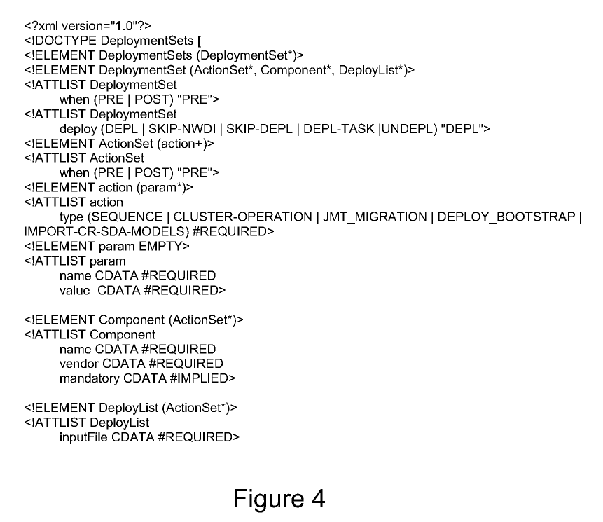

FIG. 2 is a flow diagram of a process for updating components of a multi-functional software solution. At block 210, the system updater 120 receives a DOT 130 and creates a deployment order provider 121. The deployment order provider 121 calculates a deployment sequence by extracting the information provided by the received DOT 130 at block 220. All deployment components available for update that are not described as a part of a deployment set define the default deployment set, as described in reference to FIG. 4 below. Each deployment set 131 contains order information, extracted by the deployment order provider 121 along with the actions instructions 132 and deployable components 133 described for each deployment set 131 in the DOT 130. The deployment set order information specifies if the deployment set 131 should be processed before or after the default deployment set is processed. The deployment set order information is necessary because some deployment sets require the update of certain specific deployable components in order to be updated correctly. For example, the update of a service component of a multi-functional software solution may require the update of all core components used by the service. If the core components are available for update, they should be updated before the service component. The deployment order provider 121 uses the order information of each deployment set 131 specified in the DOT 130 to determine the position of each deployment set 131 in the deployment sequence. At block 230, a check is performed to determine if there are more deployment sets 131 in the deployment sequence to be processed. If there are no more deployment sets 131 to be processed, the process exits at block 290. If there is a deployment set 131 to process, at block 240 a check is made to determine if there are pre-action instructions defined in this set. Each set of action instructions 132 contains order information, extracted by the deployment order provider 121 along with the action definitions for each set of action instructions 132 described in the DOT 130. The action instructions order information specifies if the set of action instructions 132 should be executed before (pre-action instructions) or after (post-action instructions) the deployment of the set of deployable components 133, described in each deployment set. The action instructions order information is necessary because some deployable components require a certain set of actions to be executed prior to their deployment and another set of actions to be executed after their deployment. A typical example is a multi-functional software solution that requires stopping a certain set of services in order to perform an update of a certain component. The services are stopped by a set of pre-actions specified in the deployment set of the certain component. After the update is completed, the set of services stopped during the update is restarted by a set of post-actions specified in the deployment set of the certain component. The deployment order provider 121 uses the order information of each set of action instructions 132 specified in the DOT 130 to determine the position of each set of action instructions 132 in the deployment sequence. If there are pre-action instructions defined for a specific deployable component and the deployable component is available for update, the action executor 122 executes the pre-action instructions at block 250. At block 260, the component deployer 123 updates the components specified in the deployment sequence on the multi-functional software solution 140. At block 270, a check for post-action instruction definitions is performed. If there are post-action instructions defined in this deployment set, the action executor 122 executes the post-action steps. The process repeats from block 230 to block 280 until there are no more unprocessed deployment sets in the deployment sequence. When the process exits at block 290, all available for update components are successfully updated on the multi-functional software solution 140.

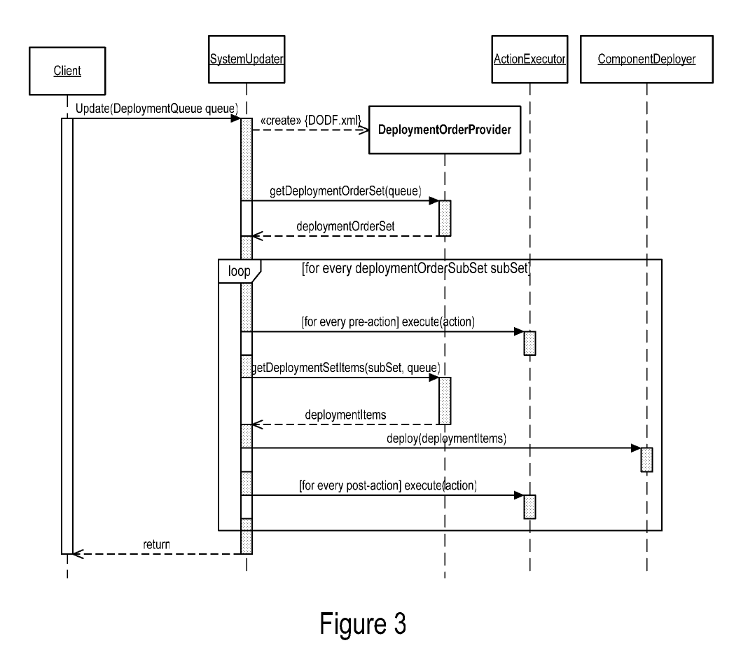

FIG. 3 is a sequence diagram of a process for updating components of a multi-functional software solution. To begin, the client 110 makes an update call to the system updater 120. In one embodiment, the client 110 passes to the system updater 120, as a parameter, a DeploymentQueue object, which contains a location containing a number of available for update deployment component archives and a DOT file. Using the DOT file provided in the object, the system updater 120 creates a deployment order provider 121. The deployment order provider 121 calculates a deployment sequence using the information from the DOT 130 and the available for update deployment components. The system updater 120 makes a getDeploymentOrderSet call to the deployment order provider 121 in order to retrieve the calculated deployment sequence. The deployment sequence contains the deployment sets 131 described in the DOT 130 in the correct order for processing. The updating process continues as specified at blocks 230-280 in reference to FIG. 2, described above. For each deployment set 131, the system updater 120 executes all pre-actions, if there are any pre-actions defined, by making an execute call to the action executor 122. Once the pre-actions are executed, the system updater 120 requests the set of deployment components 133 of the current deployment set 131 from the deployment order provider 121 by making a getDeploymentSetItems call to the deployment order provider 121. After the deployment components 133 are acquired, the system updater updates the multi-functional software solution 140 with the deployment components 133 by making a deploy call to the component deployer 123. When all deployment components 133 of the current deployment set 131 are deployed, the system updater 120 executes all post-actions, if there are any post-action defined, by making an execute call to the action executor 122. The update procedure is completed when all deployment sets 131 are processed.

FIG. 4 is an example of a document type definition (DTD) file describing a deployment order template (DOT). In this embodiment, the DOT 130 is an extensible markup language (XML) file. The DOT XML file has the following structure:
DeploymentSets. This is the root element of the DOT. It contains a plurality of deployment sets 131 descriptions. All available for update components that are not described as a part of a deployment set 131 define the default deployment set. The components of the default deployment set are updated directly with no additional actions executed during the update process. The DOT 130 defines everything that do not fit to the default deployment set via deployment sets 131 that shall be processed before or after the default deployment set update and consist of action instructions 132 and deployable components 133. This tag has no attributes.
DeploymentSet. This is a sub-tag of the DeploymentSets root element. It contains the definitions of the action instructions 132 and deployable components 133 of a single deployment set 131. Each deployment set 131 is processed as described in reference to FIG. 2 above. The DeploymentSet tag has the following attributes:
   when. This attribute contains the deployment set order information, specifying if the deployment set 131 should be processed before or after the default deployment set is processed. It has the following values:
      PRE—specifies that this deployment set 131 shall be processed before the default deployment set gets processed. This is the default value of the when attribute
      POST—specifies that this deployment set 131 shall be processed after the default deployment set is processed
   deploy. This attribute defines how the deployable components 133 in Component sub-tag shall be handled and the relationship to the other deployment sets 131. Values:
      DEPL—update all deployable components 133 from Component sub-tag. This is the default value of the deploy attribute
      SKIP-NWDI—do not update the deployable components 133 from Component sub-tag, use an alternative deployment tool for these specific components
      SKIP-DEPL—do not update the deployable components 133 from Component sub-tag
      DEPL-TASK—process the deployment set 131 if there is at least one deployment set in the DOT 130 containing deployable components 133 for update, i.e. there is at least one deployment set with attribute deploy=DEPL
      UNDEPL—process the deployment set 131 if there is at least one deployable component archive for removal. In one embodiment, the system updater 120 may identify a designated for removal deployable component by a flag stored in the deployable component archive
ActionSet. This is a sub-tag of the DeploymentSet tag. It defines a set of action instructions 132 to be executed before or after the update of the deployable components 133. The action instructions 132 are executed by the action executor 122. It has one attribute:
   when. This attribute contains the action instructions order information, specifying if the set of action instructions 132 should be executed before or after the deployment of the set of deployable components 133, described in each deployment set. It has the following values:
      PRE—specifies that this set of action instructions 132 shall be executed prior to the update of the deployable components 133 listed in the Component sub-tag of the current deployment set 131. This is the default value of the when attribute
      POST—specifies that this set of action instructions 132 shall be executed after the update of the deployable components 133 listed in the Component sub-tag of the current deployment set 131
Action. This is a sub-tag of the ActionSet tag. It defines an action instruction 132 to be executed by the action executor 122. In this embodiment, the action instructions 132 are predefined by the values of the attribute type. New action instructions 132 may be added by adding new values of the type attribute in the DTD file or by introducing new tasks for the SEQUENCE value, described below.
   type. This is an attribute of the ActionSet tag, defining the type of the action instruction 132. It is required. In this embodiment, the predefined action instruction types are:
      SEQUENCE—execute a sequence of predefined tasks. The tasks are runtime plug-in extensions, defined by a task-definition language, which is not a part of the present invention
      CLUSTER-OPERATION—execute an operation on the multi-functional software solution 140, e.g. a system restart
      JMT_MIGRATION—execute offline migration of the user specific data from one multi-functional software solution 140 to another
      DEPLOY_BOOTSTRAP—update the initialization mechanism of the multi-functional software solution 140. During startup, the initialization mechanism downloads from a database multi-functional software solution components, if the components stored in the database differ from the components stored on the file system
      IMPORT-CR-SDA-MODELS—import product model metadata into the system
Param. This is a sub-tag of the Action tag that defines a specific parameter for the action instruction 132. It has two attributes:
   name. The name of the parameter. This attribute is required
   value. The value of the parameter. This attribute is required
Component. This is a sub-tag of the DeploymentSet tag. It defines a deployable component 133 as a part of the current deployment set 131 via the unique component identifier: vendor/name. It has the following attributes:
   name. The name of the deployable component 133. This attribute is required
   vendor. The vendor of the deployable component 133. This attribute is required
   mandatory. This attribute is not required. Values: TRUE and FALSE. If at least one deployable component 133 from a deployment set 131 does not have a mandatory attribute defined or has a mandatory=TRUE attribute, the whole deployment set 131 will be processed along with all action instructions 132 and other deployable components 133 defined, as described in reference to FIG. 2 above. If all deployable components 133 from the deployment set 131 have a mandatory=FALSE attribute, the deployment set 131 will not be processed and all of its deployable components 133 will be included in the default deployment set. This attribute is useful when a deployment set has to be processed as a whole only if certain deployable components are included. If these deployable components do not require an update, than the other deployable components from the deployment set do not need special handling and can be safely deployed as a part of the default deployment set
DeployList. This is a sub-tag of the DeploymentSet tag. It defines a list of deployable components 133 as a part of the current deployment set 131. It has one attribute:
   inputFile. This attribute is required. Its value is an input file containing a list of files. Each of the listed files is a deployable component archive. The file paths specified in the input file is relative to the location of the input file

The Component and DeployList tags may have ActionSet sub-tags. In case there are such sub-tags and they contain pre-actions, these pre-actions are executed once all deployment set pre-actions are executed. In case there are post-actions in these sub-tags, they are executed before the deployment set post-actions, after all components from the deployment set are deployed.

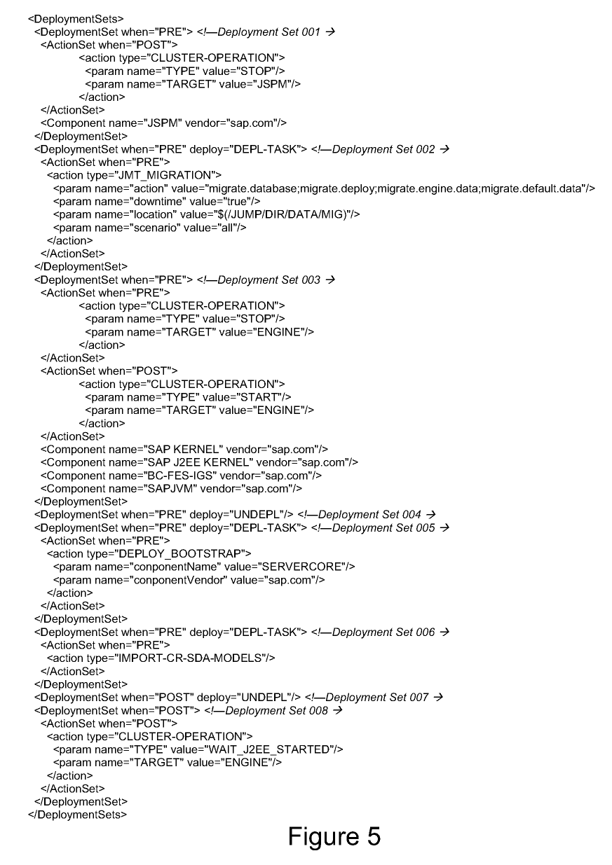

FIG. 5 is an exemplary XML representation of a DOT. In this example, there are 8 deployment sets 131 defined as follows:
Deployment Set 001: If there is a deployable component archive with unique component identifier sap.com/JSPM among the components provided for update it shall be updated prior to any other deployable component 133. The deploy attribute has default value DEPL. After its update an action instruction 132 will be executed by the action executor 122 resulting in stopping this component, if it is running on the multi-functional software solution 140. In this example, sap.com/JSPM is an update tool so this definition ensures the update tool is updated before anything else. If this deployable component archive is not provided for update the step is skipped
Deployment Set 002: If there is at least one deployable component 133 for deployment the action instruction 132 of type JMT_MIGRATION will be executed. If there are no deployable components 133 for deployment, i.e. there is no valid deployment set 131 with deploy=DEPL attribute, the step is skipped
Deployment Set 003: If there is at least one available for update deployable component archive with unique component identifier equal to sap.com/SAP KERNEL, sap.com/SAP J2EE KERNEL, sap.com/BC-FES-IGS, or sap.com/SAPJVM, the multi-functional software solution 140 will be stopped by the action executor 122 after the execution of the defined pre-action. All listed for update deployable components 133 above will be updated by the component deployer 123, if they are available for update, and the multi-functional software solution 140 will be started again by the action executor 122 as a result of the execution of the post-action defined. The deploy attribute has default value DEPL. These deployable components 133 contain vital parts of the multi-functional software solution 140, therefore a system shutdown is necessary during their update. If none of the deployable components 133 above is available for update the whole step is skipped
Deployment Set 004: If some of the available for update deployable component archives are designated for removal before default deployment set update process, they get removed from the multi-functional software solution 140 on this step. In one embodiment, the system updater 120 may identify a designated for removal deployable component by a flag stored in the deployable component archive
Deployment Set 005: If there is at least one deployment set 131 containing deployable components 133 for update, an action of type DEPLOY_BOOTSTRAP will be executed by the action executor 122 prior to the update. If there is no deployment set 131 containing deployable components 133 for update, i.e. there is no valid deployment set with deploy=DEPL attribute, the step is skipped
Deployment Set 006: If there is at least one deployment set 131 containing deployable components 133 for update an action of type IMPORT-CR-SDA-MODELS will be executed by the action executor 122 prior to the update. If there is no deployment set 131 containing deployable components 133 for update, i.e. there is no valid deployment set with deploy=DEPL attribute, the step is skipped. After the Deployment Set 006 is processed all available for update deployable components, not listed explicitly in some deployment set, will be updated directly with no additional actions executed during the update process
Deployment Set 007: If some of the available for update deployable component archives are designated for removal after default deployment set update process, they get removed from the multi-functional software solution 140 on this step. In one embodiment, the system updater 120 may identify a designated for removal deployable component by a flag stored in the component archive
Deployment Set 008: After the update process is completed the action executor 122 executes the defined post-action of type WAIT_J2EE_STARTED, which waits for the multi-functional software solution 140 to start, in order to ensure that the multi-functional software solution 140 is up and running when the update process exits at block 290 of FIG. 2, described above

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for multi-functional software solution updates, comprising:
receiving a deployment order template having a plurality of deployment sets, each of the plurality of deployment sets comprising a plurality of action instructions to be executed during an update and a plurality of deployable components to be deployed on a multi-functional software solution;
calculating a deployment sequence using the plurality of action instructions and the plurality of deployable components provided by the deployment order template;
executing the plurality of action instructions provided by the deployment order template in a succession defined by the deployment sequence; and
deploying the plurality of deployable components provided by the deployment order template to the multi-functional software solution in an order defined by the deployment sequence.

2. The method of claim 1 further comprising defining a default deployment set comprising a plurality of deployable components which do not require any action instructions to be executed during update.

3. The method of claim 2, further comprising determining if each of the plurality of deployment sets includes order information, the order information determining whether each of the plurality of the deployment sets is to be processed before or after the deployment of the default deployment set.

4. The method of claim 3, wherein calculating a deployment sequence comprises:
extracting the order information of each of the plurality of deployment sets;
adding to the deployment sequence the plurality of deployment sets that are to be processed prior to the default deployment set;
adding to the deployment sequence the default deployment set; and
adding to the deployment sequence the plurality of deployment sets that are to be processed after the deployment of the default deployment set.

5. The method of claim 1, further comprising determining if the plurality of action instructions includes order information, the order information determining whether the plurality of action instructions are to be executed before or after the deployment of the plurality of deployable components for each of the plurality of deployment sets.

6. The method of claim 5, wherein calculating a deployment sequence for each of the plurality of deployment sets further comprises:
extracting the order information of each of the plurality of action instructions;
adding to the deployment sequence the plurality of action instructions to be executed prior to the deployment of the plurality of deployable components of each of the plurality of deployment sets;
adding to the deployment sequence the plurality of deployable components of each of the plurality of deployment sets; and
adding to the deployment sequence the plurality of action instructions to be executed after the deployment of the plurality of deployable components of each of the plurality of deployment sets.

7. The method of claim 1, wherein the plurality of deployable components is provided by the deployment order template via unique component identifiers.

8. The method of claim 1, wherein the plurality of deployable components is provided by the deployment order template via a list of component archive files.

9. A system for multi-functional software solution updates, comprising:
a deployment order template to provide a plurality of deployment sets to be deployed on a multi-functional software solution; and
a system updater to perform the update of the multi-functional software solution with the deployment sets provided by the deployment order template.

10. The system of claim 9, wherein the plurality of deployment sets comprises:
a plurality of action instructions to be executed during the update; and
a plurality of deployable components to be deployed on the multi-functional software solution.

11. The system of claim 10, wherein the system updater comprises:
a deployment order provider to calculate a deployment sequence using the plurality of action instructions and deployable components provided by the deployment order template;
an action executor to execute the plurality of action instructions provided by the deployment order template in a succession defined by the deployment sequence; and
a component deployer to deploy the plurality of deployable components provided by the deployment order template to the multi-functional software solution in a succession defined by the deployment sequence.

12. A machine readable medium having a set of instructions stored therein which when executed, cause a machine to perform a set of operations for multi-functional software solution updates, comprising:
receiving a deployment order template having a plurality of deployment sets, each of the plurality of deployment sets comprising a plurality of action instructions to be executed during an update and a plurality of deployable components to be deployed on a multi-functional software solution;
calculating a deployment sequence using the plurality of action instructions and the plurality of deployable components provided by the deployment order template;
executing the plurality of action instructions provided by the deployment order template in a succession defined by the deployment sequence; and
deploying the plurality of deployable components provided by the deployment order template to the multi-functional software solution in a succession defined by the deployment sequence.

13. The machine readable medium of claim 12 having a set of instructions further comprising defining a default deployment set comprising a plurality of deployable components which do not require any action instructions to be executed during update.

14. The machine readable medium of claim 13 having a set of instructions further comprising determining if each of the plurality of deployment sets includes order information, the order information determining whether each of the plurality of the deployment sets is to be processed before or after the deployment of the default deployment set.

15. The machine readable medium of claim 14, wherein calculating a deployment sequence further comprises:
extracting the order information of each of the plurality of deployment sets;
adding to the deployment sequence the plurality of deployment sets that are to be processed prior to the default deployment set;
adding to the deployment sequence the default deployment set; and
adding to the deployment sequence the plurality of deployment sets that are to be processed after the deployment of the default deployment set.

16. The machine readable medium of claim 12 having a set of instructions further comprising determining if the plurality of action instructions includes order information, the order information determining whether the plurality of action instructions are to be executed before or after the deployment of the plurality of deployable components for each of the plurality of deployment sets.

17. The machine readable medium of claim 16, wherein calculating a deployment sequence for each of the plurality of deployment sets further comprises:
extracting the order information of each of the plurality of action instructions;
adding to the deployment sequence the plurality of action instructions to be executed prior to the deployment of the plurality of deployable components of each of the plurality of deployment sets;
adding to the deployment sequence the plurality of deployable components of each of the plurality of deployment sets; and
adding to the deployment sequence the plurality of action instructions to be executed after the deployment of the plurality of deployable components of each of the plurality of deployment sets.

18. The machine readable medium of claim 12, wherein the plurality of deployable components is provided by the deployment order template via unique component identifiers.

19. The machine readable medium of claim 12, wherein the plurality of deployable components is provided by the deployment order template via a list of component archive files.
